(19) United States
(12) Patent Application Publication
(10) Pub. No.: US 2016/0340493 A1
(43) Pub. Date: Nov. 24, 2016

(54) Alkylphenol-free Polymeric Polyphosphite Stabilizer for Rubber Compositions

(71) Applicant: Dover Chemical Corporation, Dover, OH (US)

(72) Inventors: Michael R. Jakupca, Canton, OH (US); Jacob M. Lance, New Philadelphia, OH (US); Donald R. Stevenson, Dover, OH (US)

(73) Assignee: Dover Chemical Corporation, Dover, OH (US)

(21) Appl. No.: 15/225,053

(22) Filed: Aug. 1, 2016

(51) Int. Cl. C08K 5/52; C08L 9/06; C07F 9/06; C08L 9/00; C08G 79/04

(52) U.S. Cl. CPC C08K 5/52; C08L 9/00; C08G 79/04; C07F 9/06; C08L 9/06; C08K 2201/012; C08L 2201/08

(57) ABSTRACT

The invention pertains generally to an improved polymer composition which contains at least one polymeric polyphosphite or copolymeric polyphosphite additive containing no alkylphenols. Alkylphenol-free polymeric polyphosphites offer distinct advantages over conventional phosphite technology in rubbers and rubber compounds. Polymeric polyphosphites offer improved performance in regards to the prevention of color formation during high temperature processing and NOx aging.

### TECHNICAL FIELD

The invention described herein pertains generally to the use of alkylphenol-free polymeric polyphosphites and polymeric copolyphosphites to stabilize rubber, during its production and rubber compounds during processing and use.

### BACKGROUND OF THE INVENTION

At least one purpose associated with the addition of a stabilizer to a rubber is to prevent deterioration of the rubber during processing at high temperatures and also to permit the manufacture of products with increased intrinsic quality attributable at least in part to increased resistance to thermal and light degradation during their intended use.

Many organic phosphites have been used as stabilizers, and most are based on alkylphenols. Among them are the commercially significant phosphites, tris (nonylphenyl) phosphite (TNPP) and tris (2,4-di-t-butylphenyl) (TTBP) phosphite. Historically, TNPP has been the primary low cost liquid phosphite stabilizer used in the plastic and rubber industry. Recently, however, plastic and rubber manufactures have been reluctant to use TNPP in their formulation due to concerns that one of the degradation products of TNPP (nonylphenol) may be xenoestrogenic.

Due to this concern about alkylphenols, it is advantageous to use a phosphite containing no alkylphenols. U.S. Pat. No. 8,563,637, U.S. Pat. No. 8,981,042, US published patent application US 2014/0378590 and US published patent application US2013/0190434 as well as applications claiming priority thereto and therefrom, all disclose polymeric polyphosphites and copolymeric polyphosphites, that are good polymer stabilizers and do not contain any alkylphenols. Such polymeric polyphosphites are unique since they have very low migration from polymer films, are good color stabilizers for polymers, exhibit good color stability towards gamma irradiation of polymers, and in general are a good overall stabilizer for polymers especially LLDPE and all polyolefins. This invention will illustrate the use of alkylphenol-free polymeric polyphosphites that show enhanced stabilizing performance in rubbers, e.g., polybutadiene rubber.

It has been found that using these polymeric phosphites containing no alkylphenols has some unexpected performance benefits in rubber compounds. These polyphosphites offer superior color protection during high temperature processing and long term heat aging. In addition to these color benefits they provide superior protection against gel formation.

### SUMMARY OF THE INVENTION

The present invention is directed to novel liquid polymeric polyphosphites of the general structure (I) as stabilizers for rubbers during processing.

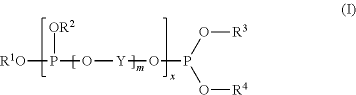

wherein
each R¹, R², R³ and R⁴ are the same or different and are independently are selected from the group consisting of C₁₂₋₂₀ alkyl, C₁₂₋₂₂ alkenyl, C₁₂₋₄₀ cycloalkyl, C₁₂₋₄₀ cycloalkylene, C₁₂₋₂₀ alkyl glycol ethers and Y—OH as an end-capping group;
each Y is independently selected from the group consisting of C₂₋₄₀ alkylene, C₇₋₄₀ cycloalkylene, C₃₋₂₀ alkyl glycol ethers, C₃₋₄₀ alkyl lactone, and —R⁷—N(R⁸)—R⁹—;
R⁷, R⁸ and R⁹ are independently selected from the group consisting of C₁₋₂₀ alkyl, C₂₋₂₂ alkenyl, C₆₋₄₀ cycloalkyl, C₇₋₄₀ cycloalkylene and H;
m is an integral value ranging from 1 to 100 inclusive;
x is an integral value ranging from 2 to 1,000 with the proviso that when —O—Y is a C₃₋₂₀ alkyl glycol ether, x is an integral value no less than 7; and further wherein
no more than two of R¹, R², R³ and R⁴ are terminated with an hydroxyl group.

The present invention is also directed to novel copolymeric polyphosphites of the general structure (II) as stabilizers for polymers during processing.

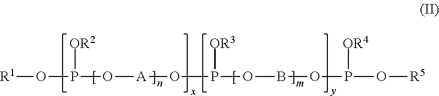

wherein
each R¹, R², R³, R⁴ and R⁵ are the same or different and are independently selected from the group consisting of C₁₂₋₂₀ alkyl, C₁₂₋₂₂ alkenyl, C₁₂₋₄₀ cycloalkyl, C₁₂₋₄₀ cycloalkenyl, C₁₂₋₂₀ alkyl glycol ethers and A-OH and B—OH as an end-capping groups;
each A and B are different and independently selected from the group consisting of C₂₋₄₀ alkylene, C₇₋₄₀ cycloalkylene, C₃₋₂₀ alkyl glycol ethers, C₃₋₄₀ alkyl lactone, and —R⁷—N(R⁸)—R⁹— wherein R⁷, R⁸ and R⁹ are independently selected from the group C₁₋₂₀ alkyl, C₂₋₂₂ alkenyl, C₆₋₄₀ cycloalkyl, C₇₋₄₀ cycloalkylene and H;
m and n are integral values ranging from 1 to 100 inclusive;
x and y are integral values ranging from 1 to 1,000 wherein x+y sum to at least 3, with the proviso that when —O-A or —O—B are C₃₋₂₀ alkyl glycol ethers, at least one of x or y is an integral value no less than 7; and further wherein
no more than two of R¹, R², R³, R⁴ and R⁵ are terminated with an hydroxyl group.

The present invention is also directed to the novel cycloaliphatic polyphosphite and copolyphosphites of U.S. Pat. No. 8,981,042 and patent application US 2014/0378590 and have the general Structure (Ill).

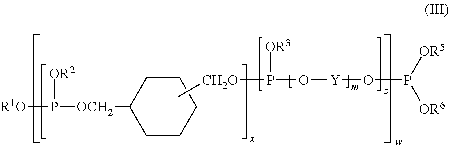

where each R¹, R², R³, R⁴, R⁵ and R⁶ are the same or different and are independently selected from the group consisting of C₁₋₂₀ alkyl, C₂₋₂₂ alkenyl, C₆₋₄₀ cycloalkyl, C₇₋₄₀ cycloalkylene, C₃₋₂₀ methoxy alkyl glycol ethers, C₃₋₂₀ alkyl glycol ethers or Y—OH (serving as an end capping moiety) for R¹, R², R³, R⁴, R⁵ and R⁶;
Y is selected from the group consisting of C₂₋₄₀ alkylene, C₂₋₄₀ alkyl lactone, and C₂₋₄₀ cycloalkyl and further comprises C₂₋₂₀ alkyl glycol ethers when Y is in the polyphosphite backbone (e.g., ethylene, propylene, caprylactone, polyalkylene glycol);
x is an integral value ranging from 8 to 1,000;
   z is an integral value ranging from 0 to 1,000 with the proviso that when z is 8 or greater, then x is an integral value ranging from 1 to 1,000;
m is an integral value ranging from 1 to 20;
w is an integral value ranging from 1 to 1,000.

The novel, polymeric polyphosphites and copolymeric polyphosphites of the general Structures (I) or (II) or (Ill), as disclosed in above referenced patents and patent applications are especially suitable for stabilization of rubber and rubber compounds. The advantages of high molecular weight polymeric phosphites are very low volatility, low migration out of the rubber being stabilized, low gel counts, and improved resistance to NOx gas. These advantages can translate into desirable properties for rubber compounds when the polymeric polyphosphites are added either singly or in combination.

This invention therefore relates to a composition that is prepared by processing a rubber compound with one of the polymeric polyphosphites disclosed in the above patents and/or applications and the process for preparing a film or molded article from said composition. The polymeric polyphosphite may be used alone or in combination with other antioxidants and polymer additives.

### DETAILED DESCRIPTION OF THE INVENTION

The best mode for carrying out the invention will now be described for the purposes of illustrating the best mode known to the applicant at the time of the filing of this invention. The examples and figures are illustrative only and not meant to limit the invention, as measured by the scope and spirit of the claims.

Unless the context clearly indicates otherwise: the word “and” indicates the conjunctive; the word “or” indicates the disjunctive; when the article is phrased in the disjunctive, followed by the words “or both” or “combinations thereof” both the conjunctive and disjunctive are intended.

As used in this application, the term “approximately” is within 10% of the stated value, except where noted.

As further used in this application, the term “rubber” or “rubbers” or “rubber compound” includes both natural and synthetic rubbers. Natural rubber, coming from latex of Hevea brasiliensis, is mainly poly-cis-isoprene containing traces of impurities like protein, dirt etc. Although it exhibits many excellent properties in terms of mechanical performance, natural rubber is often inferior to certain synthetic rubbers, especially with respect to its thermal stability and its compatibility with petroleum products.

Synthetic rubber is made by the polymerization of a variety of petroleum-based precursors called monomers. The most prevalent synthetic rubbers are styrene-butadiene rubbers (SBR) derived from the copolymerization of styrene and 1,3-butadiene. Other synthetic rubbers are prepared from isoprene (2-methyl-1,3-butadiene), chloroprene (2-chloro-1,3-butadiene), and isobutylene (methylpropene) with a small percentage of isoprene for cross-linking. These and other monomers can be mixed in various proportions to be copolymerized to produce products with a range of physical, mechanical, and chemical properties. The monomers can be produced pure and the addition of impurities or additives can be controlled by design to give optimal properties. Polymerization of pure monomers can be better controlled to give a desired proportion of cis and trans double bonds.

As used herein, synthetic rubbers includes, but is not limited to polyacrylate rubbers, ethylene-acrylate rubbers, polyester urethanes, bromo isobutylene isoprene rubbers, polybutadiene rubbers, chloro isobutylene isoprene elastomers, polychloroprene, chlorosulfonated polyethylene, epichlorohydrin, ethylene propylene elastomers, ethylene propylene diene monomers (“EPDM”), polyether urethane rubbers, perfluorocarbon rubbers, fluorinated hydrocarbons, fluoro silicone rubbers, fluorocarbon rubbers, hydrogenated nitrile butadiene rubbers, polyisoprene, isobutylene isoprene butyl rubbers, acrylonitrile butadiene, polyurethane, styrene butadiene rubbers, styrene ethylene butylene styrene copolymers, polysiloxane, vinyl methyl silicone, acrylonitrile butadiene carboxy monomer, styrene butadiene carboxy monomer, thermoplastic polyether-esters, styrene butadiene block copolymers, styrene butadiene carboxy block copolymers.

As further used in the application, synthetic rubbers includes the use of at least one rubber as an impact modifier for other polymer systems, particularly such as polystyrene. Rubber may be added to polystyrene at levels of about 10% to produce High Impact Polystryene (HIPS). The improved properties of the neat rubber will also translate into the final product when used as an impact modifier. For example the improved color and mechanical properties of the rubber stabilized by the polymeric polyphosphites of the current invention will translate into improve color and mechanical properties of the High Impact Polystrene.

In addition, the term “gum rubber” is sometimes used to describe the tree-derived natural rubber and to distinguish it from synthetic natural rubber.

The invention provides for improved rubber compositions prepared by a standard rubber processing processes. The rubber may be any of the commercially produced rubbers and/or compositions containing rubbers or rubber compounds.

The rubbers may contain polymers of monoolefins and diolefins such as polyethylene, polypropylene, polyoisobutylene, poly-1-butene, poly-4-methylpentene, polyisoprene, polybutadiene, for example high density polyethylene (HDPE), high density and high molecular weight polyethylene (HDPE-HMW), high density and ultrahigh molecular weight polyethylene (HDPE-UHMW), medium density polyethylene (MDPE), low density polyethylene (LDPE), linear low density polyethylene (LLDPE), and polymers of cycloolefins such as cyclopentene and norbornene, and blends of the polymers described above.

The rubbers may contain copolymers of monoolefins and diolefins with each other or with other vinyl monomers such as ethylene/propylene, propylene/1-butene, propylene/isobutene, propylene/butadiene, ethylene/1-butene, ethylene/1-hexene, ethylene/1-octene, isobutylene/isoprene, ethylene/alkylacrylates, ethylene/alkylmethacrylates, ethylene/vinyl acetate, ethylene/acrylic acid (and salts, ionomers, thereof), terpolymers of ethylene, propylene, and dienes such as hexadiene, dicyclopentadiene, and ethylene-norbornene.

In general the polymeric polyphosphites of this invention are added to the organic material to be stabilized in amounts from about 0.001 wt % to about 5 wt % of the weight of the organic material to be stabilized. A more preferred range is from about 0.01% to 2.0%. The most preferred range is from 0.025% to 1%.

The stabilizers of this invention may be incorporated into the organic materials at any convenient stage prior to manufacture of the film using techniques known in the art.

The stabilized polymer compositions of the invention may also contain from about 0.001% to 5%, preferably from 0.01% to 2%, and most preferably from 0.025% to 1% of other conventional stabilizers listed below or in Vanderbilt Chemicals, “Antioxidants for Rubber Selection Guide”, by Vanderbilt Chemicals, published 2013, (hereinafter “Vanderbilt Selection Guide”).

Hindered phenolic antioxidants such as 2,6-di-tert-butyl-4-methylphenol; octadecyl 3,5-di-tert-butyl-4-hydroxy-hydrocinnamate; tetrakis methylene (3,5-di-tert-butyl-4-hydroxyhydrocinnamate)methane; and tris(3,5-di-tert-butyl-4-hydroxybenzyl) isocyanate. Other phenolic antioxidants are listed in Vanderbilt Selection Guide.

Thioesters such as dilauryl thiodipropionate and distearyl thiodipropionate.

Aromatic amine stabilizers such as N, N′-diphenyl-p-phenylene-diamine. Other aromatic amine stabilizers are listed in the Vanderbilt Selection Guide.

UV absorbers such as 2-hydroxy-4-n-octyloxybenzophenone, 2(2′-hydroxy-5′-methylphenyl)-benzotriazole, and 2(2′-hydroxy-5-t-octylphenyl)-benzotriazole.

Phosphites such as tris(2,4-di-tert-butylphenyl)phosphite, distearyl pentaerythritol diphosphite, and 2,4-dicumylphenyl pentaerythritol diphosphite.

Acid neutralizers such as calcium stearate, zinc stearate, calcium lactate, calcium stearyl lactate, epoxidized soybean oil, and hydrotalcite (natural and synthetic).

Other additives such as lubricants, antistatic agents, antiblocking agents, slip agents, fire retardants, nucleating agents, impact modifiers, blowing agents, plasticizers, fillers, dyes, and pigments may be used in an amount appropriate and in combination of the invented polymeric phosphites to modify a selected property of the polymer.

Alkanol amines such as but not limited to triethanolamine and triisopropanolamine.

The polymeric phosphites (generally a liquid) of this invention are generally much more compatible with the rubber polymer than other commercially available mono-phosphites such as tris(2,4-di-t-buytlyphenol)phosphite (TTBP) and tris(nonylphenol)phosphite (TNPP). The high molecular weight and the improved compatibility offers several distinct advantages over traditional monophosphites or diphosphites. Solid phosphites such as TTBP are known to exude from polymer films and must be used at lower concentrations to minimize buildup on processing equipment. Additionally such solid monophosphites may exude to the surface of the polymer post-processing forming a layer of dust on the surface of the film.

Liquid monophosphites such as TNPP do not typically exude from the polymer during processing or post processing. However it is still desirable to have a more compatible polymeric phosphite since much of the rubber films and molded products produced are used for food packaging where the film may come into direct contact with food. It is known that whatever additives are contained in the polymer film have the potential to migrate from the polymer into the food it is in contact with. The polymeric polyphosphites of this invention exhibit far lower migration when in contact with food due to their high molecular weight.

Rubber compositions containing the polymeric polyphosphites also exhibit improved color stabilization in comparison to TNPP and TTBP. This is evident during melt processing as well as post processing. During melt processing the color, as measured by the Yellowness Index (YI) of the polymer may increase from the shear and heat degradation attributable to the extrusion or film production process. The polymeric polyphosphites produce a rubber compound of lower color (YI) when used at equal loading levels or even when used at lower loading levels.

There are many conditions post processing that the rubber compound may be exposed to that has the potential to increase the color of the polymer. Rubber compounds may be exposed to NO gases which are highly oxidative. Alkylphenols are oxidized by these gases forming color bodies in the polymer. Phosphites such as TNPP and TTBP are produced from alkylphenols and therefore contribute to the color increase of a rubber compound exposed to these gases. Since the polymeric polyphosphites of the current invention contain no alkylphenols, they do not contribute to the color increase thereby producing a product with lower color.

Rubber compounds may also be subject to gamma irradiation in medical applications to sterilize a medical device. The gamma irradiation can also decompose any alkylphenol groups in the polymer causing an increase in color. The polymer polyphosphites of this invention show far superior color hold when exposed to gamma irradiation since they are not composed of any alkylphenols.

Rubber compounds can also be exposed to elevated temperatures post processing. The elevated temperatures are very degradative to the polymer causing both color increase and loss of the polymer's mechanical properties. The polymeric polyphosphites offer equal or slightly better against the loss of mechanical properties and far superior protection against color increase.

During rubber processing it is common for small gels to form due to crosslinking of the rubber. The polymeric polyphosphites of this invention offer improved protection against the formation of these gels when compared to TNPP or TTBP.

Additionally the polymeric polyphosphites of the current invention offer a synergy with tocopherols (Vitamin E) when used in combination to stabilize a polymer. It is known in the art that Vitamin E is an excellent polymer stabilizer that can be used at a fraction of the loading level of many hindered phenol stabilizers. However it is not commonly used as a stabilizer in rubber compounds since it has the tendency to cause greatly increased color when used with traditional phosphites like TNPP and TTBP. The polymeric polyphosphites of this invention offer such improved color stability that they can be used with Vitamin E to produce a film with better color than traditional antioxidant packages using hindered phenols and TNPP or TTBP.

The Vitamin E/polymeric polyphosphite combinations are especially beneficial for protection against gas fade since the hindered phenolic may also contribute to color formation. This unique combination of Vitamin E and the polymeric polyphosphite can be used to make a rubber composition that is essentially completely resistant to gas fade.

The invention will now be described by a series of examples.

### Example 1

PPG 400 (95 g, 0.237 mol), triphenyl phosphite (73 g, 0.235 mol), a mixture of lauryl and myristyl alcohol with a hydroxyl number of about 280, (47 g, 0.235 mol), and 0.8 grams of potassium hydroxide were added together. The mixture was mixed well and heated to 160-162° C. under nitrogen and held at the temperature for 1 hour. The pressure was then gradually reduced to 0.3 mmHg and the temperature was increased to 170-172° C. over the span of 1 hour. The reaction contents were held at 170-172° C. under vacuum for 2 hours at which point no more phenol was distilling out. The vacuum was then broken by nitrogen and the crude product was cooled to 50° C. The product was a clear, colorless liquid.

### Example 2

PPG 400 (48 g, 0.12 mol), triphenyl phosphite (73 g, 0.235 mol), lauryl alcohol, (47 g, 0.235 mol), dipropylene glycol (16 g 0.12 mol) and 0.8 grams of potassium hydroxide were added together. The mixture was mixed well and heated to 160-162° C. under nitrogen and held at the temperature for 1 hour. The pressure was then gradually reduced to 0.3 mmHg and the temperature was increased to 170-172° C. over the span of 1 hour. The reaction contents were held at 170-172° C. under the vacuum for 2 hours at which point no more phenol was distilling out. The vacuum was then broken by nitrogen and the crude product was cooled to 50° C. The product was a clear, colorless liquid.

### Example 3

1,6 hexane diol (57 g, 0.48 mol), triphenyl phosphite (150 g, 0.48 mol), a mixture of lauryl and myristyl alcohol with a hydroxyl number of about 280, (97 g, 0.48 mol), and 0.8 grams of potassium hydroxide were added together. The mixture was mixed well and heated to 160-162° C. under nitrogen and held at temperature for 1 hour. The pressure was then gradually reduced to 0.3 mmHg and the temperature was increased to 170-172° C. over the span of 1 hour. The reaction contents were held at 170-172° C. under the vacuum for 2 hours at which point no more phenol was distilling out. The vacuum was then broken by nitrogen and the crude product was cooled to 50° C. The product was a hazy, colorless liquid.

### Example 4

The apparatus in Example #1 was used. 100 grams (0.69 mol) of cyclohexane dimethanol, triphenyl phosphite (237 g, 0.76 mol), a mixture of lauryl and myristyl alcohol with a hydroxyl number of about 280, (190 g, 0.95 mol), and 0.4 grams of potassium hydroxide were added. The mixture was mixed well and heated to approximately 150° C. under nitrogen and held at temperature for 1 hour. The pressure was then gradually reduced to 0.3 mm Hg and the temperature was increased to 180° C. over the span of 1 hour. The reaction contents were held at 180° C. under the vacuum for 2 hours at which point no more phenol was distilling out. The vacuum was then broken by nitrogen and the crude product was cooled to ambient temperature. The product was a liquid.

### Example 5

The apparatus in Example #1 was used. 20 grams (0.14 mol) of cyclohexane dimethanol, 7 g polypropylene glycol 400 (0.02 m), triphenyl phosphite (100 g, 0.32 mol), a mixture of lauryl and myristyl alcohol with a hydroxyl number of about 280 (136 g, 0.69 mol) and 0.4 grams of potassium hydroxide were added. The mixture was mixed well and heated to approximately 150° C. under nitrogen and held at temperature for 1 hour. The pressure was then gradually reduced to 0.3 mm Hg and the temperature was increased to 180° C. over the span of 1 hour. The reaction contents were held at 180° C. under the vacuum for 2 hours at which point no more phenol was distilling out. The vacuum was then broken by nitrogen and the crude product was cooled to ambient temperature. The product was a liquid.

Characteristics of the various synthesized additives may be characterized at least in part by the following tables.

TABLE I

| | Example | | | | |
|---|---|---|---|---|---|
| | #1 | #2 | #3 | #4 | #5 |
| appearance | liquid | liquid. | liquid. | liquid | liquid. |
| Acid Value | 0.01 | 0.05 | 0.01 | 0.01 | 0.01 |
| (“AV”) | | | | | |
| (initial) | | | | | |
| % P | 4.9 | 5.9 | 8.9 | 7.6 | 6.0 |
| Avg. MW | 9,111 | 7,250 | 31,515 | 13,957 | 1,651 |

The following examples are meant to illustrate the benefits of the current invention over convential phosphites. They are not intended to cover every single application which these could be used.

### Example 6

### High Temperature Oven Aging

High temperature aging is known to have oxidative effects on polymers and rubbers and often cause color and viscosity issues in polymers and rubbers when exposed to high temperatures. Alkylphenols such as those found in many phosphite stabilizers may also oxidize when exposed to higher temperatures and form color bodies in the polymer and/or rubber contributing to the color problem. This is equally applicable to phenolic primary antioxidants.

The polymeric polyphosphites of the current invention show a marked improvement in color hold in contrast to an alkylphenol containing phosphite such as TNPP as illustrated in Table II in which various samples were compounded and subjected to high temperature aging at 88° C. for various amounts of time as well as viscosity testing (measured in Mooney units).

TABLE II

| | Formulation* | | |
|---|---|---|---|
| | Sample #1 | Sample #2 | Sample #3 |
| Unstablized cis-polybutadiene rubber | 99.2 | 99.2 | 99.2 |
| TNPP | 0.5 | | |
| Example #1 | | 0.5 | |
| Example #4 | | | 0.5 |
| Irganox ® 1076 | 0.3 | 0.3 | 0.3 |

Color

| | | | |
|---|---|---|---|
| Initial | 12.0 | 12.9 | 12.8 |
| 24 hrs | 49.9 | 13.2 | 13.0 |
| 48 hrs | 52.0 | 45.7 | 44.1 |
| 72 hrs | 58.0 | 47.3 | 45.3 |
| 96 hrs | 65.8 | 47.9 | 46.2 |
| % increase | ~448% | ~271% | ~261% |

Mooney Viscosity**

| | | | |
|---|---|---|---|
| Initial | 36 | 36 | 36 |
| 24 hrs | 30 | 36 | 37 |
| 48 hrs | 31 | 36 | 37 |
| 72 hrs | 45 | 40 | 39 |
| 96 hrs | 69 | 39 | 39 |
| % increase | ~92% | ~8% | ~8% |

*all percentages are by weight percent
**Studies performed on a Monsanto MV 2000 Viscometer @ 100° C.

As illustrated above, the use of a polymeric polyphosphite (e.g., Example #1 or Example #4) showed improved color control during heat aging and better viscosity control compared to the standard phosphite TNPP.

### Example 7

### NOₓ Oven Aging

NOx gases are known to have oxidative effects on polymers and often cause color issues in polymers exposed to them. Alkylphenols such as those found in many phosphite stabilizers may also oxidize when exposed to these gases and form color bodies contributing to the color problem.

The polymeric polyphosphites of the current invention show a marked improvement in color hold in comparison to an alkylphenol containing phosphite such as TNPP.

The following formulations using unstabilized styrene-butadiene rubber were compounded and pressed into 3×3 inch plaques at 150° C. for 3 minutes. The plaques were then cut in half for aging studies. The color of the samples was taken at periodic intervals. NO testing involved placing the plaques in a NO chamber at 65° C., the samples removed and color measuring by YI (yellowness index) in which the higher the number, the darker the color. The samples were also placed in a temperature controlled room (72° F. equivalently 22.2° C.) and samples removed and color tested similar to before.

TABLE III

| | Formulation* | | |
|---|---|---|---|
| | Sample #1 | Sample #2 | Sample #3 |
| Unstablized SBR rubber | 99.0 | 99.4 | 99.0 |
| Irganox ® 1520 | 0.2 | 0.2 | 0.2 |
| (2-methyl-4,6- | | | |
| bis(octylsulfanylmethyl)phenol) | | | |
| TNPP | 0.8 | | |
| Example #1 | | 0.4 | 0.8 |

Color (YI) for NOₓ/Gas Fade Aging

| | | | |
|---|---|---|---|
| Initial | 9.9 | 9.7 | 10.0 |
| Day 1 | 12.7 | 12.4 | 9.4 |
| Day 4 | 18.2 | 17.6 | 14.8 |
| Day 7 | 21.4 | 20.7 | 19.1 |
| % increase | ~116% | ~113% | ~91% |

Color (YI) for Ambient Aging

| | | | |
|---|---|---|---|
| Initial | 10.2 | 10.1 | 10.1 |
| Day 1 | 9.5 | 9.2 | 8.1 |
| Day 4 | 10.5 | 9.2 | 7.7 |
| Day 7 | 10.7 | 9.4 | 7.7 |
| % increase | ~5% | ~−7% | ~−24% |

The formulations with the polymeric polyphosphite of example #1 performed better when compared to the more traditional TNPP even at lower concentrations.

The best mode for carrying out the invention has been described for purposes of illustrating the best mode known to the applicant at the time. The examples are illustrative only and not meant to limit the invention, as measured by the scope and merit of the claims. The invention has been described with reference to preferred and alternate embodiments. Obviously, modifications and alterations will occur to others upon the reading and understanding of the specification. It is intended to include all such modifications and alterations insofar as they come within the scope of the appended claims or the equivalents thereof.

What is claimed is:

1. A process to improve the NOₓ stability of a rubber compared to tris(nonylphenyl)phosphite, comprising the step of adding at least one homopolymer polyphosphite or copolymer polyphosphite of Formulas (I), (II) or (Ill) to the rubber:
Formula (I) 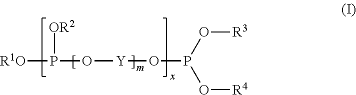
wherein in Formula (I)
each R¹, R², R³ and R⁴ are the same or different and are independently selected from the group consisting of C₁₂₋₂₀ alkyl, C₁₂₋₂₂ alkenyl, C₁₂₋₄₀ cycloalkyl, C₁₂₋₄₀ cycloalkylene, C₁₂₋₂₀ alkyl glycol ethers and Y—OH as an end-capping group;
each Y is independently selected from the group consisting of C₂₋₄₀ alkylene, C₇₋₄₀ cycloalkylene, C₃₋₂₀ alkyl glycol ethers, C₃₋₄₀ alkyl lactone, and —R⁷—N(R⁸)—R⁹—;
R⁷, R⁸ and R⁹ are independently selected from the group consisting of C₁₋₂₀ alkyl, C₂₋₂₂ alkenyl, C₆₋₄₀ cycloalkyl, C₇₋₄₀ cycloalkylene and H;
m is an integral value ranging from 1 to 100 inclusive;
x is an integral value ranging from 2 to 1,000 with the proviso that when —O—Y is a C₃₋₂₀ alkyl glycol ether, x is an integral value no less than 7; and further wherein
no more than two of R¹, R², R³ and R⁴ are terminated with an hydroxyl group;
Formula (II) 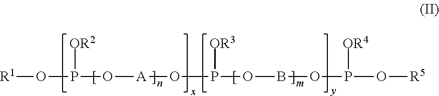
wherein in Formula (II)
each R¹, R², R³, R⁴ and R⁵ are the same or different and are independently selected from the group consisting of C₁₂₋₂₀ alkyl, C₁₂₋₂₂ alkenyl, C₁₂₋₄₀ cycloalkyl, C₁₂₋₄₀ cycloalkenyl, C₁₂₋₂₀ alkyl glycol ethers and A-OH and B—OH as an end-capping groups;
each A and B are different and independently selected from the group consisting of C₂₋₄₀ alkylene, C₇₋₄₀ cycloalkylene, C₃₋₂₀ alkyl glycol ethers, C₃₋₄₀ alkyl lactone, and —R⁷—N(R⁸)—R⁹— wherein R⁷, R⁸ and R⁹ are independently selected from the group C₁₋₂₀ alkyl, C₂₋₂₂ alkenyl, C₆₋₄₀ cycloalkyl, C₇₋₄₀ cycloalkylene and H;
m and n are integral values ranging from 1 to 100 inclusive;
x and y are integral values ranging from 1 to 1,000 wherein x+y sum to at least 3, with the proviso that when —O-A or —O—B are C₃₋₂₀ alkyl glycol ethers, at least one of x or y is an integral value no less than 7; and further wherein
no more than two of R¹, R², R³, R⁴ and R⁵ are terminated with an hydroxyl group; or
Formula (III) 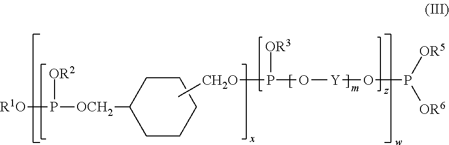
wherein in Formula (III)
each R¹, R², R³, R⁴, R⁵ and R⁶ are the same or different and are independently selected from the group consisting of C₁₋₂₀ alkyl, C₂₋₂₂ alkenyl, C₆₋₄₀ cycloalkyl, C₇₋₄₀ cycloalkylene, C₃₋₂₀ methoxy alkyl glycol ethers, C₃₋₂₀ alkyl glycol ethers or Y—OH (serving as an end capping moiety) for R¹, R², R³, R⁴, R⁵ and R⁶;
Y is selected from the group consisting of C₂₋₄₀ alkylene, C₂₋₄₀ alkyl lactone, and C₂₋₄₀ cycloalkyl and further comprises C₂₋₂₀ alkyl glycol ethers when Y is in the polyphosphite backbone (e.g., ethylene, propylene, caprylactone, polyalkylene glycol);
x is an integral value ranging from 8 to 1,000;
z is an integral value ranging from 0 to 1,000 with the proviso that when z is 8 or greater, then x is an integral value ranging from 1 to 1,000;
m is an integral value ranging from 1 to 20;
w is an integral value ranging from 1 to 1,000; and
combinations of formula (I) or Formula (II) or Formula (III).

2. The process of claim 1 wherein
a yellowness index of the rubber increases by less than 113% when equal amounts of TNPP and polymeric polyphosphite are added to separate rubbers and each rubber is exposed to NOₓ at 65° C. for 7 days.

3. The process of claim 1 wherein
the rubber is selected from the group consisting of natural and synthetic rubbers.

4. The process of claim 3 wherein
the natural rubber is poly-cis-isoprene; and
the synthetic rubber is selected from the group consisting of styrene-butadiene rubbers, isoprene, chloroprene, isobutylene, polyacrylate rubbers, ethylene-acrylate rubbers, polyester urethanes, bromo isobutylene isoprene rubbers, polybutadiene rubbers, chloro isobutylene isoprene elastomers, polychloroprene, chlorosulfonated polyethylene, epichlorohydrin, ethylene propylene elastomers, ethylene propylene diene monomers, polyether urethane rubbers, perfluorocarbon rubbers, fluorinated hydrocarbons, fluoro silicone rubbers, fluorocarbon rubbers, hydrogenated nitrile butadiene rubbers, polyisoprene, isobutylene isoprene butyl rubbers, acrylonitrile butadiene, polyurethane, styrene butadiene rubbers, styrene ethylene butylene styrene copolymers, polysiloxane, vinyl methyl silicone, acrylonitrile butadiene carboxy monomer, styrene butadiene carboxy monomer, thermoplastic polyether-esters, styrene butadiene block copolymers, styrene butadiene carboxy block copolymers.

5. A process to improve the long term heat aging of a rubber compared to the addition of tris(nonylphenyl)phosphite, comprising the step of adding at least one homopolymer polyphosphite or copolymer polyphosphite of Formulas (I), (II) or (III) to the rubber:
Formula (I) 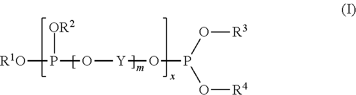
wherein in Formula (I)
each R¹, R², R³ and R⁴ are the same or different and are independently selected from the group consisting of C₁₂₋₂₀ alkyl, C₁₂₋₂₂ alkenyl, C₁₂₋₄₀ cycloalkyl, C₁₂₋₄₀ cycloalkylene, C₁₂₋₂₀ alkyl glycol ethers and Y—OH as an end-capping group;
each Y is independently selected from the group consisting of C₂₋₄₀ alkylene, C₇₋₄₀ cycloalkylene, C₃₋₂₀ alkyl glycol ethers, C₃₋₄₀ alkyl lactone, and —R⁷—N(R⁸)—R⁹—;
R⁷, R⁸ and R⁹ are independently selected from the group consisting of C₁₋₂₀ alkyl, C₂₋₂₂ alkenyl, C₆₋₄₀ cycloalkyl, C₇₋₄₀ cycloalkylene and H;
m is an integral value ranging from 1 to 100 inclusive;
x is an integral value ranging from 2 to 1,000 with the proviso that when —O—Y is a C₃₋₂₀ alkyl glycol ether, x is an integral value no less than 7; and further wherein
no more than two of R¹, R², R³ and R⁴ are terminated with an hydroxyl group;
Formula (II) 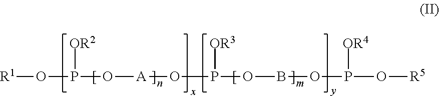
wherein in Formula (II)
each R¹, R², R³, R⁴ and R⁵ are the same or different and are independently selected from the group consisting of C₁₂₋₂₀ alkyl, C₁₂₋₂₂ alkenyl, C₁₂₋₄₀ cycloalkyl, C₁₂₋₄₀ cycloalkenyl, C₁₂₋₂₀ alkyl glycol ethers and A-OH and B—OH as an end-capping groups;
each A and B are different and independently selected from the group consisting of C₂₋₄₀ alkylene, C₇₋₄₀ cycloalkylene, C₃₋₂₀ alkyl glycol ethers, C₃₋₄₀ alkyl lactone, and —R⁷—N(R⁸)—R⁹— wherein R⁷, R⁸ and R⁹ are independently selected from the group C₁₋₂₀ alkyl, C₂₋₂₂ alkenyl, C₆₋₄₀ cycloalkyl, C₇₋₄₀ cycloalkylene and H;
m and n are integral values ranging from 1 to 100 inclusive;
x and y are integral values ranging from 1 to 1,000 wherein x+y sum to at least 3, with the proviso that when —O-A or —O—B are C₃₋₂₀ alkyl glycol ethers, at least one of x or y is an integral value no less than 7; and further wherein
no more than two of R¹, R², R³, R⁴ and R⁵ are terminated with an hydroxyl group; or
Formula (III) 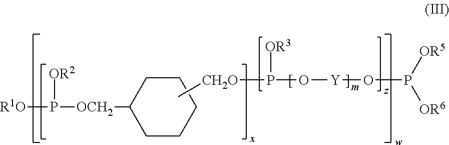
wherein in Formula (III)
each R¹, R², R³, R⁴, R⁵ and R⁶ are the same or different and are independently selected from the group consisting of C₁₋₂₀ alkyl, C₂₋₂₂ alkenyl, C₆₋₄₀ cycloalkyl, C₇₋₄₀ cycloalkylene, C₃₋₂₀ methoxy alkyl glycol ethers, C₃₋₂₀ alkyl glycol ethers or Y—OH (serving as an end capping moiety) for R¹, R², R³, R⁴, R⁵ and R⁶;
Y is selected from the group consisting of C₂₋₄₀ alkylene, C₂₋₄₀ alkyl lactone, and C₂₋₄₀ cycloalkyl and further comprises C₂₋₂₀ alkyl glycol ethers when Y is in the polyphosphite backbone (e.g., ethylene, propylene, caprylactone, polyalkylene glycol);
x is an integral value ranging from 8 to 1,000;
z is an integral value ranging from 0 to 1,000 with the proviso that when z is 8 or greater, then x is an integral value ranging from 1 to 1,000;
m is an integral value ranging from 1 to 20;
w is an integral value ranging from 1 to 1,000; and
combinations of formula (I) or Formula (II) or Formula (III).

6. The process of claim 5 wherein
a yellowness index of the rubber is less than an original value when equal amounts of TNPP and polymeric polyphosphite are added to separate rubbers and each rubber is exposed to ambient aging for 7 days.

7. The process of claim 5 wherein
the rubber is selected from the group consisting of natural and synthetic rubbers.

8. The process of claim 7 wherein
the natural rubber is poly-cis-isoprene; and
the synthetic rubber is selected from the group consisting of styrene-butadiene rubbers, isoprene, chloroprene, isobutylene, polyacrylate rubbers, ethylene-acrylate rubbers, polyester urethanes, bromo isobutylene isoprene rubbers, polybutadiene rubbers, chloro isobutylene isoprene elastomers, polychloroprene, chlorosulfonated polyethylene, epichlorohydrin, ethylene propylene elastomers, ethylene propylene diene monomers, polyether urethane rubbers, perfluorocarbon rubbers, fluorinated hydrocarbons, fluoro silicone rubbers, fluorocarbon rubbers, hydrogenated nitrile butadiene rubbers, polyisoprene, isobutylene isoprene butyl rubbers, acrylonitrile butadiene, polyurethane, styrene butadiene rubbers, styrene ethylene butylene styrene copolymers, polysiloxane, vinyl methyl silicone, acrylonitrile butadiene carboxy monomer, styrene butadiene carboxy monomer, thermoplastic polyether-esters, styrene butadiene block copolymers, styrene butadiene carboxy block copolymers.

9. A process to improve the Yellowness Index of a rubber when exposed to temperatures in excess of room temperature in comparison to the addition of tris(nonylphenyl)phosphite, comprising the step of adding at least one homopolymeric polyphosphite or copolymeric polyphosphite of Formulas (I), (II) or (III) to the rubber:
Formula (I) 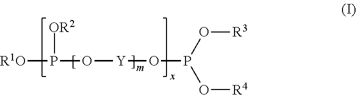
wherein in Formula (I)
each R¹, R², R³ and R⁴ are the same or different and are independently selected from the group consisting of C₁₂₋₂₀ alkyl, C₁₂₋₂₂ alkenyl, C₁₂₋₄₀ cycloalkyl, C₁₂₋₄₀ cycloalkylene, C₁₂₋₂₀ alkyl glycol ethers and Y—OH as an end-capping group;
each Y is independently selected from the group consisting of C₂₋₄₀ alkylene, C₇₋₄₀ cycloalkylene, C₃₋₂₀ alkyl glycol ethers, C₃₋₄₀ alkyl lactone, and —R⁷—N(R⁸)—R⁹—;
R⁷, R⁸ and R⁹ are independently selected from the group consisting of C₁₋₂₀ alkyl, C₂₋₂₂ alkenyl, C₆₋₄₀ cycloalkyl, C₇₋₄₀ cycloalkylene and H;
m is an integral value ranging from 1 to 100 inclusive;
x is an integral value ranging from 2 to 1,000 with the proviso that when —O—Y is a C₃₋₂₀ alkyl glycol ether, x is an integral value no less than 7; and further wherein
no more than two of R¹, R², R³ and R⁴ are terminated with an hydroxyl group;
Formula (II) 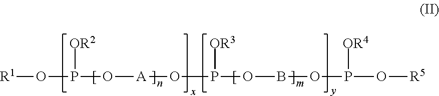
wherein in Formula (II)
each R¹, R², R³, R⁴ and R⁵ are the same or different and are independently selected from the group consisting of C₁₂₋₂₀ alkyl, C₁₂₋₂₂ alkenyl, C₁₂₋₄₀ cycloalkyl, C₁₂₋₄₀ cycloalkenyl, C₁₂₋₂₀ alkyl glycol ethers and A-OH and B—OH as an end-capping groups;
each A and B are different and independently selected from the group consisting of C₂₋₄₀ alkylene, C₇₋₄₀ cycloalkylene, C₃₋₂₀ alkyl glycol ethers, C₃₋₄₀ alkyl lactone, and —R⁷—N(R⁸)—R⁹— wherein R⁷, R⁸ and R⁹ are independently selected from the group C₁₋₂₀ alkyl, C₂₋₂₂ alkenyl, C₆₋₄₀ cycloalkyl, C₇₋₄₀ cycloalkylene and H;
m and n are integral values ranging from 1 to 100 inclusive;
x and y are integral values ranging from 1 to 1,000 wherein x+y sum to at least 3, with the proviso that when —O-A or —O—B are C₃₋₂₀ alkyl glycol ethers, at least one of x or y is an integral value no less than 7; and further wherein
no more than two of R¹, R², R³, R⁴ and R⁵ are terminated with an hydroxyl group; or
Formula (III) 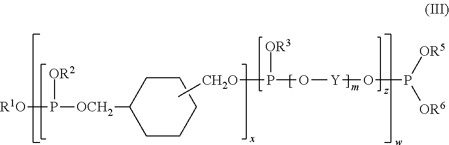
wherein in Formula (III)
each R¹, R², R³, R⁴, R⁵ and R⁶ are the same or different and are independently selected from the group consisting of C₁₋₂₀ alkyl, C₂₋₂₂ alkenyl, C₆₋₄₀ cycloalkyl, C₇₋₄₀ cycloalkylene, C₃₋₂₀ methoxy alkyl glycol ethers, C₃₋₂₀ alkyl glycol ethers or Y—OH (serving as an end capping moiety) for R¹, R², R³, R⁴, R⁵ and R⁶;
Y is selected from the group consisting of C₂₋₄₀ alkylene, C₂₋₄₀ alkyl lactone, and C₂₋₄₀ cycloalkyl and further comprises C₂₋₂₀ alkyl glycol ethers when Y is in the polyphosphite backbone (e.g., ethylene, propylene, caprylactone, polyalkylene glycol);
x is an integral value ranging from 8 to 1,000;
z is an integral value ranging from 0 to 1,000 with the proviso that when z is 8 or greater, then x is an integral value ranging from 1 to 1,000;
m is an integral value ranging from 1 to 20;
w is an integral value ranging from 1 to 1,000; and
combinations of formula (I) or Formula (II) or Formula (III).

10. The process of claim 9 wherein
a yellowness index of the rubber increases by less than 350% when equal amounts of TNPP and polymeric polyphosphite are added to separate rubbers and each rubber is exposed to an elevated temperature of 88° C. for 96 hours.

11. The process of claim 9 wherein
the rubber is selected from the group consisting of natural and synthetic rubbers.

12. The process of claim 11 wherein
the natural rubber is poly-cis-isoprene; and
the synthetic rubber is selected from the group consisting of styrene-butadiene rubbers, isoprene, chloroprene, isobutylene, polyacrylate rubbers, ethylene-acrylate rubbers, polyester urethanes, bromo isobutylene isoprene rubbers, polybutadiene rubbers, chloro isobutylene isoprene elastomers, polychloroprene, chlorosulfonated polyethylene, epichlorohydrin, ethylene propylene elastomers, ethylene propylene diene monomers, polyether urethane rubbers, perfluorocarbon rubbers, fluorinated hydrocarbons, fluoro silicone rubbers, fluorocarbon rubbers, hydrogenated nitrile butadiene rubbers, polyisoprene, isobutylene isoprene butyl rubbers, acrylonitrile butadiene, polyurethane, styrene butadiene rubbers, styrene ethylene butylene styrene copolymers, polysiloxane, vinyl methyl silicone, acrylonitrile butadiene carboxy monomer, styrene butadiene carboxy monomer, thermoplastic polyether-esters, styrene butadiene block copolymers, styrene butadiene carboxy block copolymers.

13. A process to improve the Mooney viscosity of a rubber in comparison to the addition of tris(nonylphenyl)phosphite, comprising the step of adding at least one homopolymer polyphosphite or copolymer polyphosphite of Formulas (I), (II) or (III) to the rubber:
Formula (I) 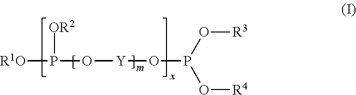
wherein in Formula (I)
each R¹, R², R³ and R⁴ are the same or different and are independently selected from the group consisting of C₁₂₋₂₀ alkyl, C₁₂₋₂₂ alkenyl, C₁₂₋₄₀ cycloalkyl, C₁₂₋₄₀ cycloalkylene, C₁₂₋₂₀ alkyl glycol ethers and Y—OH as an end-capping group;
each Y is independently selected from the group consisting of C₂₋₄₀ alkylene, C₇₋₄₀ cycloalkylene, C₃₋₂₀ alkyl glycol ethers, C₃₋₄₀ alkyl lactone, and —R⁷—N(R⁸)—R⁹—;
R⁷, R⁸ and R⁹ are independently selected from the group consisting of C₁₋₂₀ alkyl, C₂₋₂₂ alkenyl, C₆₋₄₀ cycloalkyl, C₇₋₄₀ cycloalkylene and H;
m is an integral value ranging from 1 to 100 inclusive;
x is an integral value ranging from 2 to 1,000 with the proviso that when —O—Y is a C₃₋₂₀ alkyl glycol ether, x is an integral value no less than 7; and further wherein
no more than two of R¹, R², R³ and R⁴ are terminated with an hydroxyl group;
Formula (II) 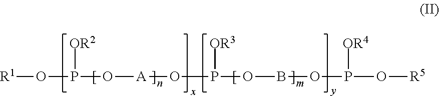
wherein in Formula (II)
each R¹, R², R³, R⁴ and R⁵ are the same or different and are independently selected from the group consisting of C₁₂₋₂₀ alkyl, C₁₂₋₂₂ alkenyl, C₁₂₋₄₀ cycloalkyl, C₁₂₋₄₀ cycloalkenyl, C₁₂₋₂₀ alkyl glycol ethers and A-OH and B—OH as an end-capping groups;
each A and B are different and independently selected from the group consisting of C₂₋₄₀ alkylene, C₇₋₄₀ cycloalkylene, C₃₋₂₀ alkyl glycol ethers, C₃₋₄₀ alkyl lactone, and —R⁷—N(R⁸)—R⁹— wherein R⁷, R⁸ and R⁹ are independently selected from the group C₁₋₂₀ alkyl, C₂₋₂₂ alkenyl, C₆₋₄₀ cycloalkyl, C₇₋₄₀ cycloalkylene and H;
m and n are integral values ranging from 1 to 100 inclusive;
x and y are integral values ranging from 1 to 1,000 wherein x+y sum to at least 3, with the proviso that when —O-A or —O—B are C₃₋₂₀ alkyl glycol ethers, at least one of x or y is an integral value no less than 7; and further wherein
no more than two of R¹, R², R³, R⁴ and R⁵ are terminated with an hydroxyl group; or
Formula (III) 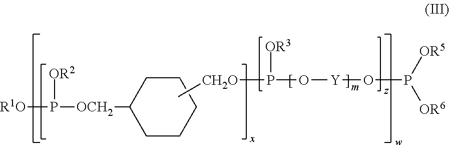
wherein in Formula (III)
each R¹, R², R³, R⁴, R⁵ and R⁶ are the same or different and are independently selected from the group consisting of C₁₋₂₀ alkyl, C₂₋₂₂ alkenyl, C₆₋₄₀ cycloalkyl, C₇₋₄₀ cycloalkylene, C₃₋₂₀ methoxy alkyl glycol ethers, C₃₋₂₀ alkyl glycol ethers or Y—OH (serving as an end capping moiety) for R¹, R², R³, R⁴, R⁵ and R⁶;
Y is selected from the group consisting of C₂₋₄₀ alkylene, C₂₋₄₀ alkyl lactone, and C₂₋₄₀ cycloalkyl and further comprises C₂₋₂₀ alkyl glycol ethers when Y is in the polyphosphite backbone;
x is an integral value ranging from 8 to 1,000;
z is an integral value ranging from 0 to 1,000 with the proviso that when z is 8 or greater, then x is an integral value ranging from 1 to 1,000;
m is an integral value ranging from 1 to 20;
w is an integral value ranging from 1 to 1,000; and
combinations of formula (I) or Formula (II) or Formula (III).

14. The process of claim 13 wherein
a Mooney viscosity of the rubber increases by less than 50% when equal amounts of TNPP and polymeric polyphosphite are added to separate rubbers and each rubber is exposed to an elevated temperature of 88° C. for 96 hours.

15. The process of claim 9 wherein
the rubber is selected from the group consisting of natural and synthetic rubbers.

16. The process of claim 11 wherein
the natural rubber is poly-cis-isoprene; and
the synthetic rubber is selected from the group consisting of styrene-butadiene rubbers, isoprene, chloroprene, isobutylene, polyacrylate rubbers, ethylene-acrylate rubbers, polyester urethanes, bromo isobutylene isoprene rubbers, polybutadiene rubbers, chloro isobutylene isoprene elastomers, polychloroprene, chlorosulfonated polyethylene, epichlorohydrin, ethylene propylene elastomers, ethylene propylene diene monomers, polyether urethane rubbers, perfluorocarbon rubbers, fluorinated hydrocarbons, fluoro silicone rubbers, fluorocarbon rubbers, hydrogenated nitrile butadiene rubbers, polyisoprene, isobutylene isoprene butyl rubbers, acrylonitrile butadiene, polyurethane, styrene butadiene rubbers, styrene ethylene butylene styrene copolymers, polysiloxane, vinyl methyl silicone, acrylonitrile butadiene carboxy monomer, styrene butadiene carboxy monomer, thermoplastic polyether-esters, styrene butadiene block copolymers, styrene butadiene carboxy block copolymers.
